(19) United States
(12) Patent Application Publication
(10) Pub. No.: US 2012/0143624 A1
(43) Pub. Date: Jun. 7, 2012

(54) m-ERP system

(76) Inventor: Prasanna Kumar Jena, (US)

(21) Appl. No.: 12/960,524

(22) Filed: Dec. 5, 2010

(51) Int. Cl. G06Q 50/00; G06Q 10/00

(52) U.S. Cl. 705/3

(57) ABSTRACT

This system involves two levels of integration of information. At one level it integrates the enterprise business transactions with the electronic medical records of patients—for each medical service provider like a doctor, a lab or even a hospital. So a medical service provider like a doctor can conduct all his business form one system.

At another level it integrates electronic medical records of a patient from different sources like doctors, dentists, labs and hospitals. So a patient can manage all his or her medical transactions in one system or workbench. A patient could visit multiple service providers or even different geographical locations but the medical system of reference for the patient does not have to change.

The m-ERP system achieves this by first centralized collection of information from medical service providers. Later the system achieves greater benefits by sharing this collected information by methods of Authorization and Nomination.

Our new medical records system m-ERP is a method and system for integrating enterprise business transactions of hospitals and doctors with medical records of patients. In this system the medical records from different medical service providers are centralized and distributed to other service providers as authorized by the patient. It is essentially an integrated Electronic Medical Records system.

### BACKGROUND

Patients and doctors have struggled to maintain and retrieve the medical records of all treatments in an easy and accessible manner. Recently there have been some developments with new software applications being developed for maintaining the medical records for respective doctors or hospitals. It is a very good development that medical records are now being stored in electronic form. But it still suffers from one major functional deficiency. Most of the patients do not visit or consult only one doctor or even one hospital no matter how big it is. If a patient visited multiple doctors or hospitals there is no easy way of combining the medical records from multiple locations.

This problem is aggravated for the people who are on the road for a living—the salesmen, the consultants and the travellers. If you have to work at location ‘A’ for four days a week and then live at home at location ‘B’ for three days over the weekend, you need a seamless integration between the medical records at both the locations. If you are travelling then you feel the need to carry all your medical information with yourself else there could be a medical information crisis if you have any health emergency.

The solution to this is the centralization of these medical records from different sources. But how is this possible? Why should hospital ‘A’ share its medical records with hospital ‘B’ or even an individual specialist ‘C’? How would a patient be able to see his or her medical records in one view? All these medical service providers including labs would have to write to the same system/server so that the records get centralized and can be retrieved. This would be a secure system and hence the privacy concerns of both the patient and doctor are addressed.

These medical records would not include any financial information of the medical service providers. The patient would be the person deciding who can access his/her medical record. By following a system of authorizations it would be decided whether Doctor-2 can see what diagnosis was done by Doctor-1 on Patient-1. Even without EMR, this is the situation now. An outgoing patient can pay small fee to get a copy of all medical records from the hospital/clinic and is free to share it with the medical service provider of his/her choice. So our system of centralized medical records is not changing the ownership of medical records. Instead of moving the old medical records the patient is allowing the new doctor to view them on our central server—the m-ERP system.

### SUMMARY

This is a system of records to maintain and disseminate medical transactions arising out of interactions between doctor and patient, between laboratory and patient and also by the patient him/herself when personal records are entered and updated. The serial recording of transactions is necessary to store medical history of the patients involved.

One aspect of this database of medical transactions is that the primary driver of these records is the patient. The records are secured and segregated by patient. In many existing EMR systems, the records are secured by doctor because it is the doctor or the hospital who own and operates the EMR. Therein lie the biggest difference of the m-ERP system with the traditional EMR systems. Multiple select queries can be run to identify records specific to a doctor. But the entry of records is done on behalf of a patient.

One way of looking at the system is that it is the patient not the doctor who owns the medical records. A quick example would clarify the concept further. Let us consider Patient-1 who has a PPO medical insurance. Patient-1 can go to Doctor-1 followed by Doctor-2 for treatment. If the two doctors have EMR systems, they would store their medical records separately in two different EMR systems. The patient would not see a combined view of his treatment. If Patient-1 decides to visit Doctor-3 for further treatment there is still no easy way to share of past diagnosis by Doctor-1 and Doctor-2 with Doctor-3. But if the three doctors are subscribed to our m-ERP system, then not only does the patient have access to a combined view of the historical records—each of these doctors would have access to the same information too.

Another way of looking at the proposed system is the centralization of medical records. This kind of access to medical records of a particular patient is not possible without centralization of medical records. In our above example Doctor-3 cannot view the earlier diagnosis of Doctor-1 and Doctor-2 together unless they are centralized.

Another way of looking at the proposed system is that if the medical insurance companies are Interested, they can be part of the system too. That way subscribing to a new insurance becomes smooth and any claim of pre-existing condition can be examined and resolved quickly. With the new Healthcare law coming into force, where pre-existing conditions are no longer influencing treatment and payment of premiums, no patient privacy is intruded upon.

Another aspect of the m-ERP system is that it is not just a system for storing medical records of individual patients. The doctors and hospitals who would subscribe to this system would be able to conduct all their daily routine work by this system. That would include activities like managing appointments, managing back office accounting and book-keeping, automatic billing of insurance companies and patients wherever necessary.

The aspect of m-ERP system that needs to be clarified is that it is only the medical transactions between patients and doctors that would be centralized. All other transactions like appointments, financial transactions would be stored in the hospital or clinic's server and hence localized. These enterprise management transactions would not be accessible to anyone other than the respective owning doctor or Hospital. The logical question is—does it compromise the confidentiality of the doctor-patient relationship? The answer is NO. Here is why—when Patient-1 would visit Doctor-3, Patient-1 can take all medical records from Doctor-1 and Doctor-2 and share them with his/her new doctor Doctor-3. Unless Doctor-3 understands what was diagnosed and how it was treated, future treatment may not be most effective and efficient. Our concept of centralization of medical records only makes the sharing of medical history between doctors easier.

Data security is of paramount importance in m-ERP system. If any doctor who has access to m-ERP system can see any patient's medical history that would compromise personal information of the patient and can also lead to unfair marketing strategy. So data access would mimic the current rules in the world of decentralized and non-electronic medical records. Currently a patient discloses his/her medical history to the future doctor or hospital. Our m-ERP system also does the same. There is a system of Patient Authorization whereby the patient would authorize the new doctor or hospital to view the records pertaining to a past doctor or hospital. The patient would have the final say in disclosing relevant treatment records or all medical records. For example if the patient is a female and she is pregnant for the second time, she would decide whether she should disclose all her medical records from first pregnancy or even treatment for a fractured index finger on left hand that happened last year. Treatment for the index finger would have no relevance for new pregnancy. So the patient can decide not to share such irrelevant information.

Another aspect of m-ERP system is facilitating end-of-life care and treatment decisions. When a patient is in no condition to make decisions, we need a system of nomination to allow other people make such decisions on his or her behalf. For example Patient-1 can nominate Nominee-2 to make such decisions on his/her behalf when Patient-1 in incapable of making medical decisions. This is a standard procedure in hospitals before major surgeries. But major surgeries are not the only occasions a person becomes incapable of making medical decisions. So a permanent system of Nomination is in order. In our example Nominee-2 can decide on behalf of Patient-1 that Doctor-3 can access the relevant medical records of treatment between Patient-1 and Doctor-1 and Patient-1 and Doctor-2.

Another aspect of this m-ERP system is the transferability of medical records between multiple electronic medical record storage systems like between m-ERP system and an EHR system. The future view is that the medical world would be served by multiple electronic medical record systems. The guiding principle of m-ERP system is that individual patients would not have to struggle to collect his or her medical records from different doctors. But it is also unrealistic to assume that all doctors in the country or even in a particular city would subscribe to our m-ERP system. In that scenario when a patient moves between doctors belonging to different EHR systems, there would arise a need to combine the medical records from multiple EHR systems. So our proposed m-ERP system would allow the patient to download and upload the medical transactions history in different formats like text file, Excel file, comma delimited file, XML file etc. Our m-ERP system would also allow upload of medical transactions from another EHR system in different file formats like text, Comma Delimited (CSV) or XML format.

Patient would have to decide which m-ERP system or EHR system is his or her parent system and which one is the temporary system. Patients would have to import data from temporary system into their parent system.

### BRIEF DESCRIPTION OF THE DRAWINGS

FIG. 1—m-ERP System shows at a higher level how different consumers of the medical records system like patients, doctors, laboratories, hospitals and perhaps insurance companies would use it.

FIG. 2—m-ERP Architecture shows in greater detail how the centralized medical records system would work.

FIG. 3—Patient's transactions describes how an individual patient transaction flows through the m-ERP system.

FIG. 4—Patient Authorization describes how the important concept of patient authorization is going to work in the m-ERP system.

FIG. 5—Modules Architecture describes the overall arrangement of different modules in the system.

FIG. 6—Appt. to Acct. describes how business transactions would flow through the system from an Appointment to generating the relevant accounts.

FIG. 7—Req to Pay describes how the business process flows starting from a requisition to a making a payment.

FIG. 8—Req to Assets describes how the business process flows starting from creating a Requisition for purchase of an Asset to putting the Asset in use.

FIG. 9—Patient Nomination describes the concept of Nomination that can be critical for end of life care situations.

FIG. 10—Inter m-ERP dataflow shows how a patient can combine medical records from two separate m-ERP systems.

### DETAILED DESCRIPTION

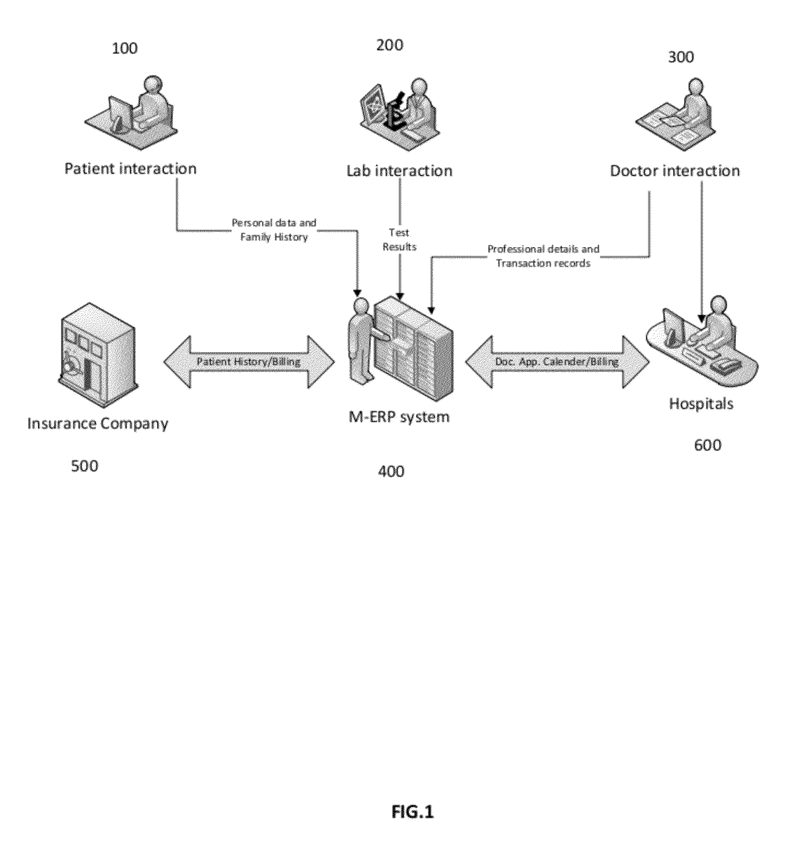

FIG. 1 shows the relation of different participants to the m-ERP system 400. The Patient 100 applies for membership to the system and submits personal details of membership including the particular level of access and privilege that they require. The m-ERP system 400 would charge members different fees depending on facilities they want to use. Similarly a lab 200 or a Doctor 300 would also apply for membership to the m-ERP 400 system. Typically the Doctor 300 and lab 200 would get their membership when they buy m-ERP 400 system for installation. That would have an automatic membership requirement for the patients. This membership would be the basic membership without the bells and whistles that a full-fledged membership would provide.

Once membership is obtained, the patient 100 would retain authority to modify personal details like address, contact preferences, membership status etc. But the patient 100 would only have read-only access to the test details posted by the lab 200 and transaction details posted by the Doctor 300. Similarly the lab would have read only access to the patient's 100 contact details and the Doctor's 300 test recommendations. The Lab 200 would not be able to see patient's medical history. The Lab 200 would not be able to access any patient records unless the patient requests for service from the respective Lab 200. The request for service by the Patient 100 can be made either by swiping the membership card at the counter or by providing other membership details which can be verified by the Lab 200. Once the test results are posted, the lab 200 would not be allowed to modify any changes to the test results.

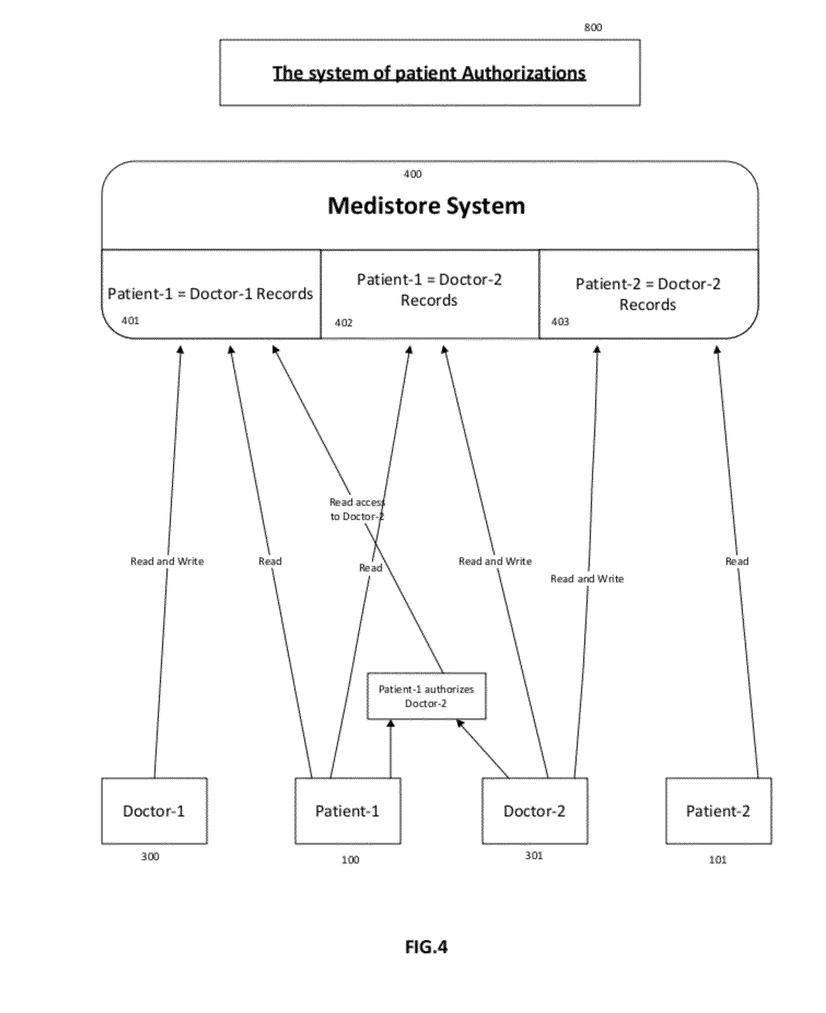

The Doctor 300 is another vital link in the m-ERP system. The Doctor 300 would be part of a large hospital 600 or an independent clinic. Either way the Doctor would receive the membership by installing the m-ERP 400 system for taking care of daily business like appointments and accounting as well as transaction records in the form of electronic medical records (EMR). The Doctor 300 would not be able to view the medical history of the patient 100 unless the patient 100 discloses past medical history by way of Authorization 800 which is described in detail in FIG. 4. Let us consider the situation between a patient 100 and a doctor 300 now without the m-ERP 400. The patient 100 arrives at the office of the doctor 300 and requests treatment. The patient 100 discloses as much information about medical history as he or she deems necessary. The existence of m-ERP system 400 does not alter that situation. The Doctor 300 has access to the treatment records he or she has done. The existence of m-ERP system 400 does not alter that too. The value added in having the m-ERP 400 system is the Authorization process by which the patient 100 discloses past medical records to the current doctor 300. The current doctor 300 can see how the diagnosis was done earlier. The process of Authorization 800 can be used to share earlier lab test results with the current doctor 300. One of the benefits of sharing earlier diagnosis and lab results with current doctor 300 is making sure that we do not get into a situation of over-treatment or over-testing. That saves time and money for everybody concerned.

Coming back to FIG. 1, the other aspect of this system is that the Hospitals 600 can use the system to track the appointment calendar of their doctors and patients can book appointments online with the available doctors. The same m-ERP system can double up as a billing system once the service has been provided. The Hospitals 600 and individual doctors 300 can fall back on the system for accurate billing for the services provided. The m-ERP system can also be used to track the collection of the bills. So a Hospital would use the m-ERP system for multiple purposes like appointment management, billing, collection management, medical records storage and other back office functions that a typical hospital management system would provide.

Still referring to FIG. 1, the m-ERP system 400 can be a great help to the medical insurance company 500. The insurance company 500 can refer to the m-ERP system to understand the details of treatment provided to the subject patient 100. This kind of access would speed up the payments for treatments and improve accuracy too. Let us consider a simple situation. A patient 100 has been treated at a particular hospital 600. When the hospital 600 bills the medical insurance provider 500, the insurance provider just has to login to their account and review the treatment provided. They 500 would not need to ask for multiple clarifications. That would speed up the billing resolution and also provide accuracy to the process.

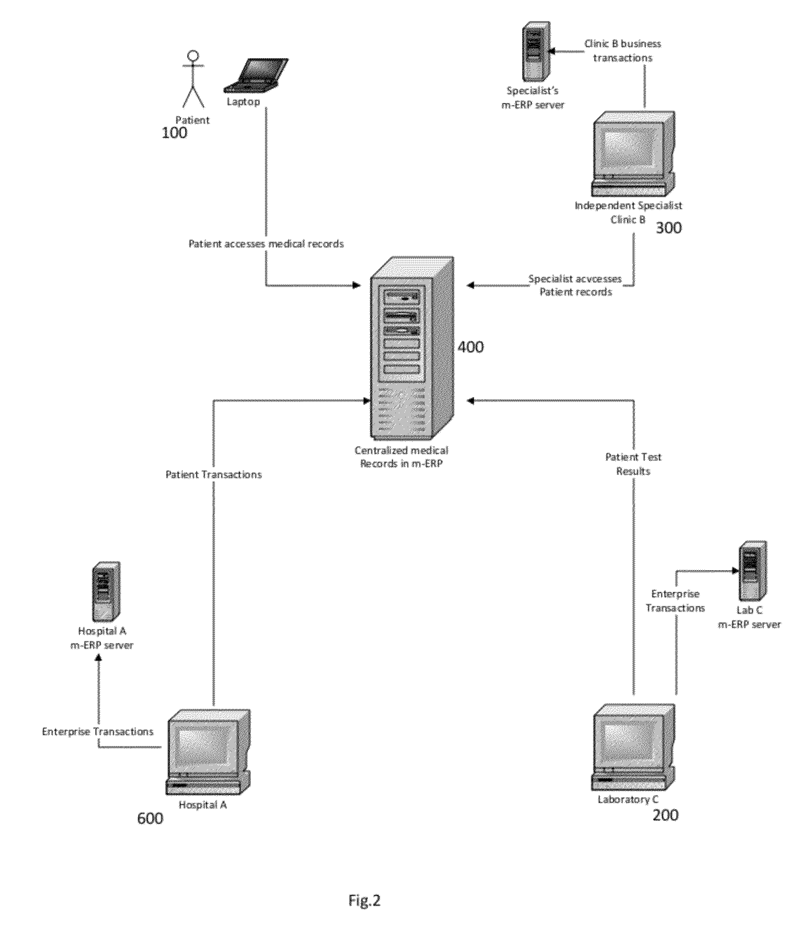

In FIG. 2 we have another explanation of the m-ERP 400 system deployment. Each of the corporate subscribers like hospital 600 and lab 200 would have their own server and installation. That would help them conduct their day to day business like accounting, purchasing, payments, receivables management etc. At the same time they would also be managing their patient 100 appointments. The patients and the corporate entities would be register with the centralized m-ERP system 400. Centralization of the registration process would generate unique serial numbers for the patients and corporate entities. This is extremely important in managing the centralized system successfully. In addition to posting their enterprise transaction in their m-ERP system, the corporate subscribers post the patient transactions like test results and patient diagnosis into the centralized m-ERP system 400. The centralization of the patient transaction is the key to m-ERP as this allows the patient's medical history to be independent of any hospital's EMR system. Let us assume that the hospital 600 had an EMR system. In that case the patient 100 would have to access the specific EMR system to see his medical history with the particular hospital 600. That would not allow the patient to take his medical record across t other doctors and hospitals with the same amount of freedom as he or she would have with m-ERP system 400.

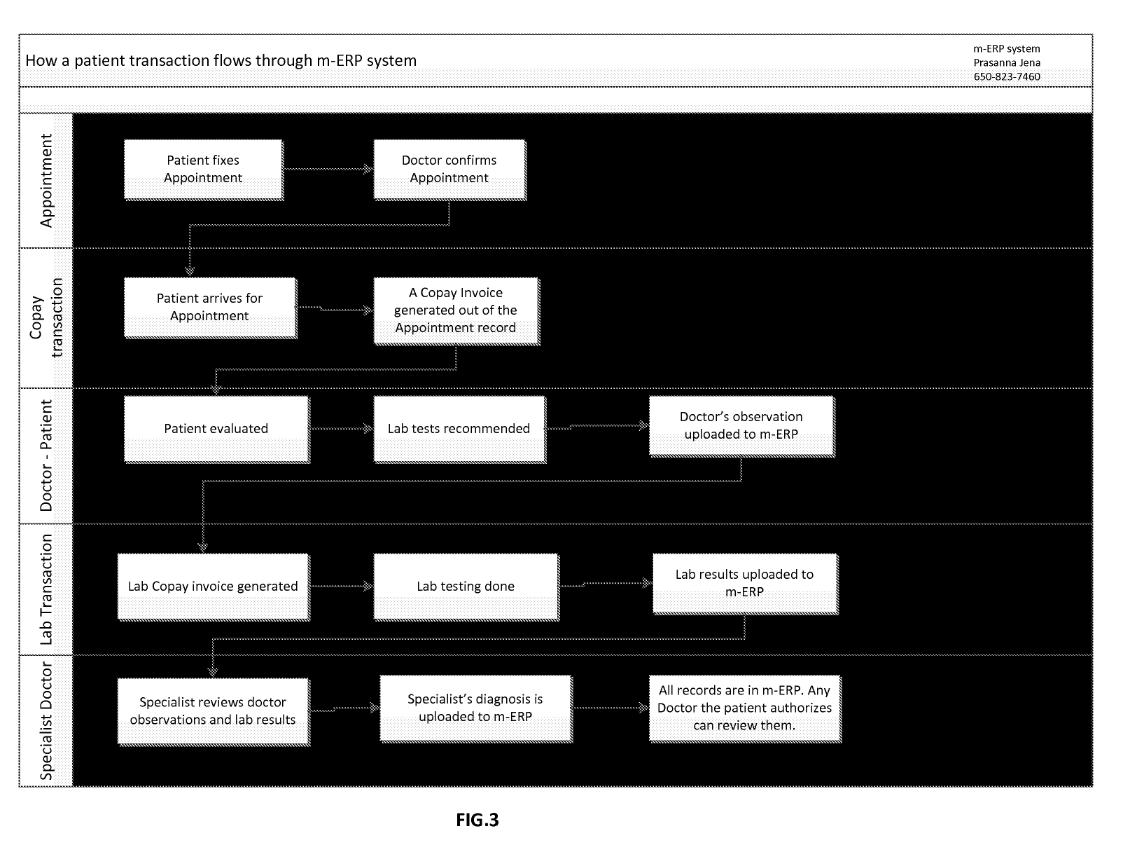

In FIG. 3 there is an illustration of a patient 100 going through a simple medical transaction. First the patient 100 fixes an appointment with a doctor 300 and the doctor confirms the appointment. So now the date and time of the appointment is set. Next the patient 100 arrives for the appointment. A copay invoice as necessary is generated and paid in the m-ERP system. The copay amount is dependent on the medical insurance policy that the patient 100 has subscribed to. Next the focus shifts to the real business matters—the transaction between the doctor 300 and patient 100. Doctor 300 evaluates the patient 100 and recommends a lab test and also recommends that the patient 100 see a specialist with the lab results. All this are uploaded to the m-ERP system 400. Now the patient 100 visits the lab and does a couple of things. First a copay invoice is generated if required and payment is made, second the patient 100 authorizes the lab 200 to access the patient's relevant records like doctor's 300 recommendations. Once the Lab 200 is ready, it conducts the recommended test and uploads the test results to m-ERP 400. Thus the test results are available to the patient 100 and the doctor 300 for immediate review. Later the patient 100 can release the results to other doctors or hospitals as deemed necessary. That is exactly what the patient 100 does when he or she decides to see a specialist. The specialist doctor 101 can review the diagnosis of the first doctor 100 and the lab 200. No patient 100 has to carry their lab test results or doctor recommendations with themselves. It is all available in the m-ERP system 400.

The discussion of one particular patient 100 transaction brings us to the important concept of Authorizations 800. It is by this process of Authorizations 800 that a patient 100 allows doctor2 301 have a look at the diagnosis of doctor1 100 and lab tests done earlier. In this case Doctor2 301 would have to have membership to m-ERP 400 to be able to review authorized transactions. Let us review FIG. 4. Patient-1 100 visits Doctor-1 300 and that transaction is recorded in the m-ERP system 400. Then Patient-1 100 needs to visit Doctor-2 301. Doctor-2 301 needs to review the medical records 401 between Patient-1 100 and Doctor-1 300 to understand the earlier diagnosis. This is different than the access Doctor-2 301 has for the medical records 403 of Patient-2 101. Because Patient-2 101 is already being treated by Doctor-2 301, Doctor-2 301 has complete access to those records 403. So Patient-1 100 Authorizes 800 Doctor-2 301 to have read only access to the medical records 401 from Doctor-1 300. Patient-1 100 can use blanket authorization to allow Doctor-2 301 have a look at complete life history of Patient-1 100. But usually that might not be necessary.

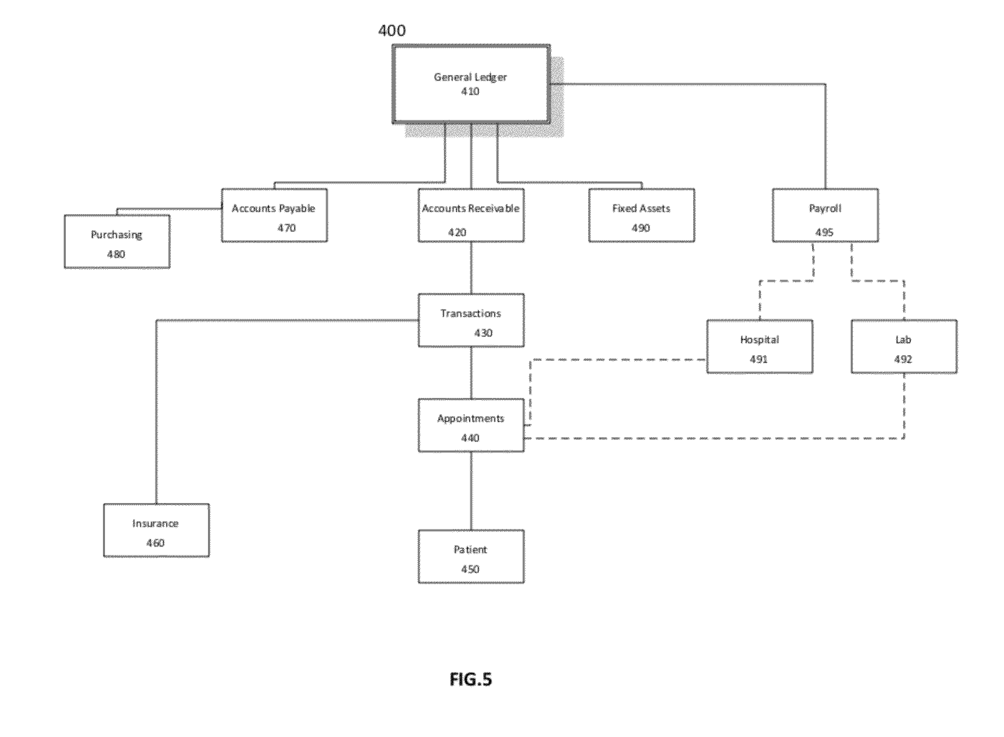

Referring now to FIG. 5, it is the logical arrangement of different functional areas in m-ERP system. The patient module 450 is linked to the Appointments module 440 which in turn is linked to the Transactions module 430. The Transactions module 430 is connected to the central module General Ledger 410 via the Accounts Receivable module 420. Other modules feeding data into the central module General Ledger 410 are Accounts Payable 470, Fixed Assets 490 and Payroll 495. Another important module feeding data into General Ledger 410 is Purchasing 480 via Accounts Payable module 470. The Payroll module 495 is connected optionally to the Appointments module 440. The assumption is that the corporate entity that installed m-ERP solution is either a doctor's clinic/hospital or a Lab. If it is a Hospital that handles lab operations too, then the entity would be identified as Hospital. The modules are arranged and connected to each other in this manner to facilitate enterprise transactions for the corporate entity.

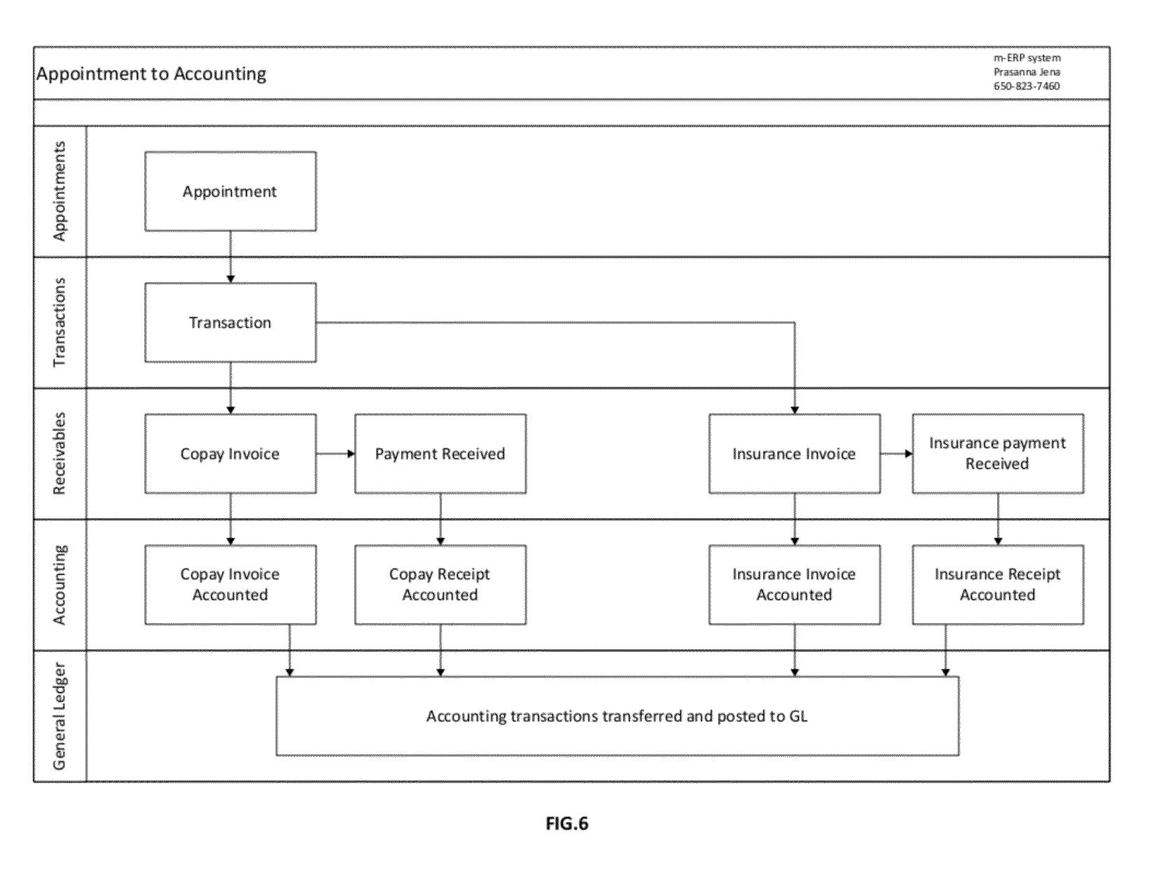

In FIG. 6 we are showing the flow of information from Appointments 440 to General Ledger 410. An Appointment is fixed first and confirmed. The Appointment is later converted to a Transaction 430 and interfaced to Receivables module 420 where a Copay Invoice is generated and payment from Patient collected. Now these two documents—the Copay Invoice and the Payment are interfaced to Accounting module where we would run accounting for transactions in a centralized manner. Later these accounting entries are interfaced to General Ledger 410.

That was the flow for Appointments and Transactions. The other flow is the one generated later when the insurance provider is billed. That generates an Insurance invoice in the Accounts Receivable module 420. The Insurance invoice would be accounted in the Accounting module. Later when payment is received, it also has to be accounted for in the Accounting module. Subsequently these accounting transactions would have to be interfaced to the General Ledger module 410. This is our flow of information from Appointment 440 to the General Ledger module 410.

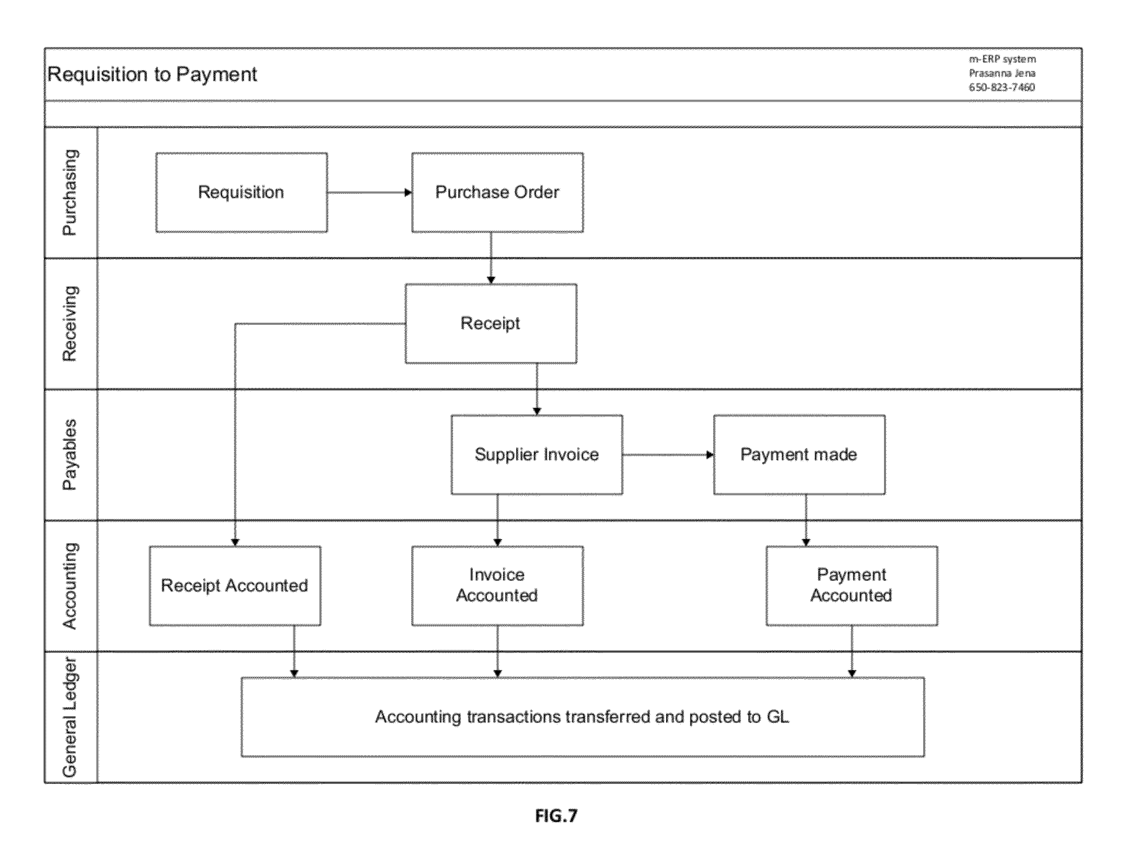

Now let us discuss the flow of information from a Requisition to Payment as shown in FIG. 7. We start with a Requisition in the Purchasing module 480. There could be different approval requirements in different enterprises. Once the Requisition is approved, it would be converted to a Purchase Order in the same Purchasing module 480. This Purchase Order has to be sent out to the Supplier and the Supplier has to deliver the goods or services. Once the goods/services are received, a Receipt would be generated. This Receipt should be accounted and liability recognized. Later these liability transactions should be transferred to General Ledger 410. Later an invoice would be received from the Supplier in the Payables module 470. Once the Supplier invoice is received, it should be accounted for and the liability recognized earlier might need to change accounts. The Supplier invoice would be accounted and accounting entries transferred to General Ledger 410. After taking the Payment Terms into account, the Supplier invoice would need to be paid. Once payment is made in Accounts Payable module 470, we would need to clear up liability by cash payment. This Payment would need to be accounted for and later the accounting entries would need to be transferred to General Ledger 410.

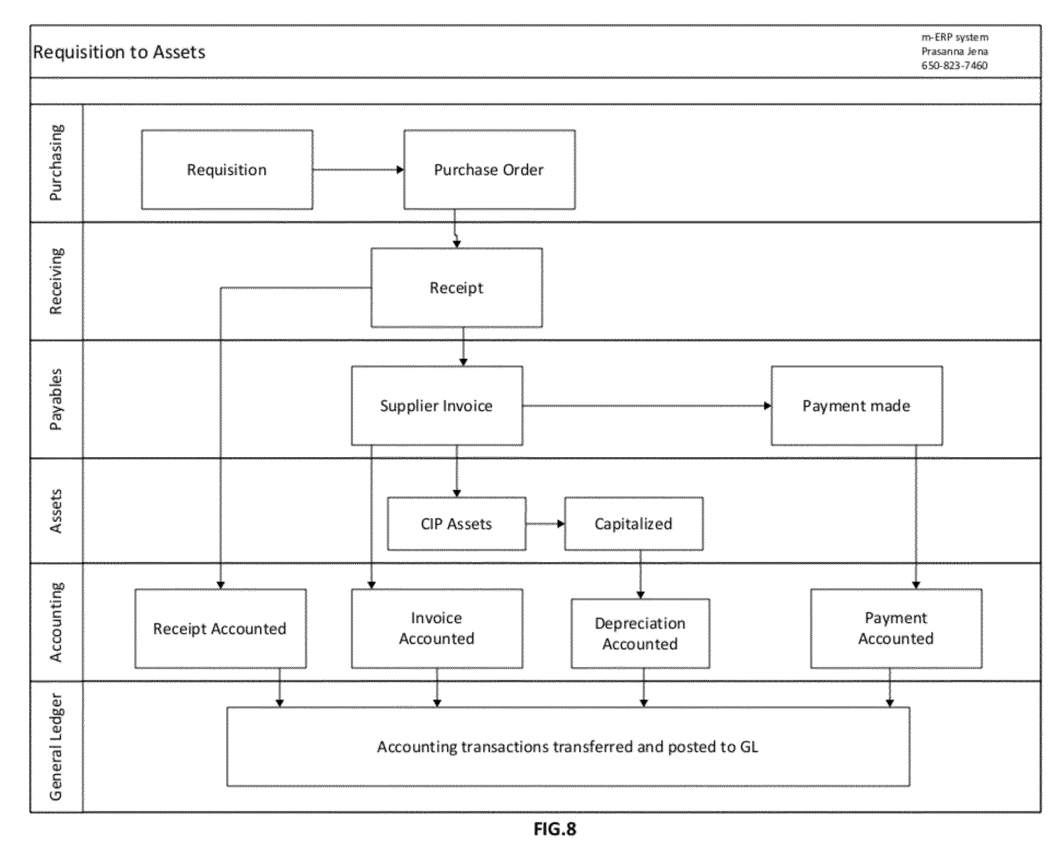

In FIG. 8 we have a slight variation of the data flow from FIG. 7. Here we describe the flow of information through modules for a purchase and installation of Fixed Asset. In both Hospital and Lab environments it is a common situation to buy Assets like different testing and monitoring equipment and then depreciate them in legally allowed rates. We start with a Requisition in the Purchasing module 480. There could be different approval requirements in different enterprises. Once the Requisition is approved, it would be converted to a Purchase Order in the same Purchasing module 480. This Purchase Order has to be sent out to the Supplier and the Supplier has to deliver the goods or services. Once the goods/services are received, a Receipt would be generated. This Receipt should be accounted and liability recognized. Later these liability transactions should be transferred to General Ledger 410. Later an invoice would be received from the Supplier in the Payables module 470. Once the Supplier invoice is received, it should be accounted for and the liability recognized earlier might need to change accounts. The Supplier invoice would be accounted and accounting entries transferred to General Ledger 410. After taking the Payment Terms into account, the Supplier invoice would need to be paid. Once payment is made in Accounts Payable module 470, we would need to clear up liability by cash payment. This Payment would need to be accounted for and later the accounting entries would need to be transferred to General Ledger 410. Here is the variation from the process flow of FIG. 7. The supplier invoice is interfaced to Fixed Assets module 490 to select the Fixed Asset details. The Fixed Assets is put in CIP status if it is part of a larger Fixed Assets purchase and installation else it is put to work and depreciation starts. If the Asset is put in CIP status then it needs to be capitalized so that the date of service is recorded and depreciation starts. Depreciation has to be accounted for and the accounting entries need to be transferred to General Ledger 410.

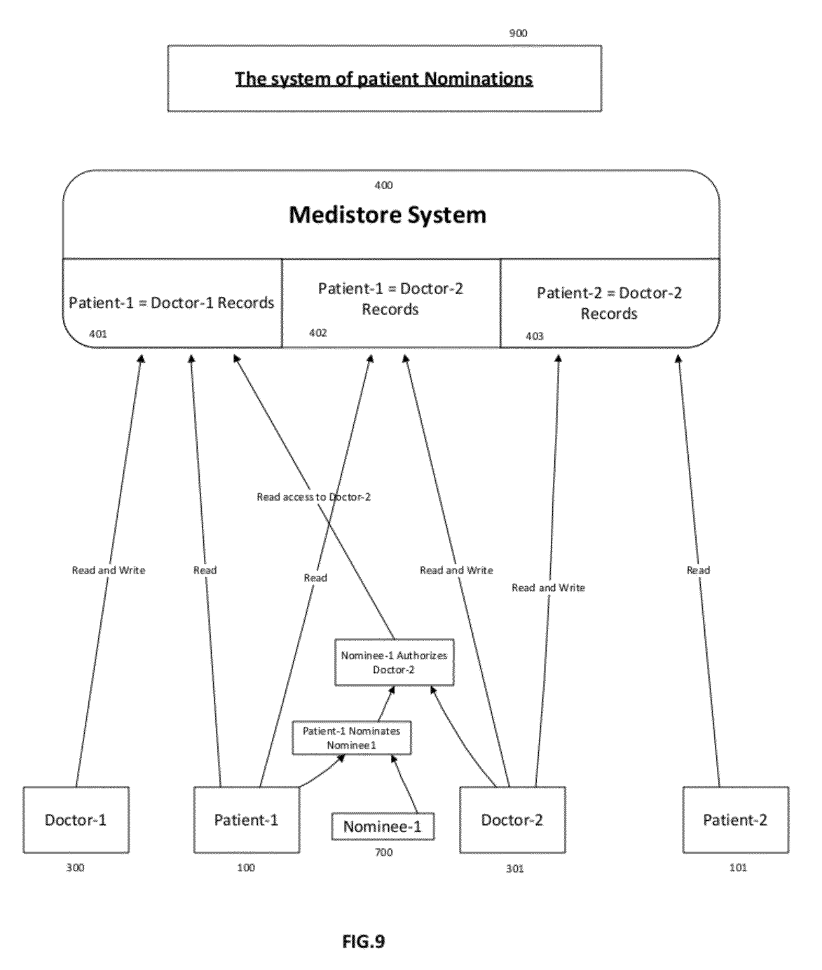

That brings us to FIG. 9 to review one more important concept of m-ERP that is Nomination 900. The concept of Nomination 900 is very important from end-of-life-care point of view. In many aspects it is comparable to the concept of Authorization 800 as described in FIG. 4. Let us review the case of Nomination 900 in FIG. 9. Patient-1 100 visits Doctor-1 300 and that transaction is recorded in the m-ERP system 400. Then Patient-1 100 needs to visit Doctor-2 301. Doctor-2 301 needs to review the medical records 401 between Patient-1 100 and Doctor-1 300 to understand the earlier diagnosis. This is different than the access Doctor-2 301 has for the medical records 403 of Patient-2 101. Because Patient-2 101 is already being treated by Doctor-2 301, Doctor-2 301 has complete access to those records 403. So Patient-1 100 needs to Authorize Doctor-2 301 to have read only access to the medical records 401 from Doctor-1 300. But we have a situation on our hands. Patient-1 100 is incapable of taking such decisions. But hold on—Patient-1 100 has nominated Nominee-1 700 to take care of these niceties! Nominee 700 understands the gravity of the situation and Doctor-2 301 is authorized by Nominee 700 to have a read access to medical records 401 of Patient-1 100 and Doctor-1 300. Please note that Nominee 700 does not have any access to the medical records of Patient-1 100 even as the Nominee can allow another doctor (Doctor-2 101) in this case to review the earlier medical records of Patient-1.

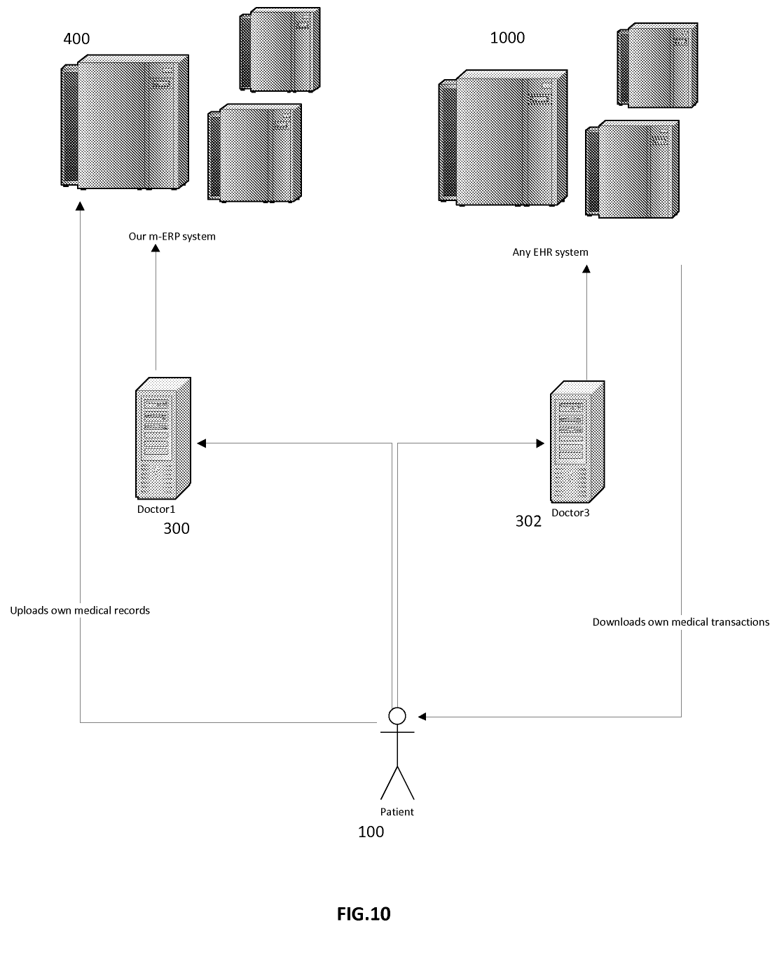

Another important point to discuss is the possibility of transferring data between the m-ERP system and another HER system. Let us have a look at the situation in FIG. 10. Patient-1 100 needs to consult Doctor-3 302 who is not a subscriber to our m-ERP system 400. Let us say Doctor-3 302 has a separate EHR system 1000. Patient-1 100 can obtain the relevant medical records from Doctor-3 302 or the EHR system 1000 and upload them to our m-ERP system 400. Our m-ERP system would allow upload of outside medical records in text, CSV, XML formats. Alternately Patient-1 100 can simply type in the diagnosis details from Doctor-3 302 if the number of transactions is not too many. Similarly we would also allow download of medical records in text, CSV and XML format. Patients can download their medical transactions in text, CSV and XML format from m-ERP system 400. This way, patients would retain ownership of their medical records even if they move in and out of different systems.

What is claimed is:

1. The m-ERP system is a concept of centralizing medical information from various sources—doctors, laboratories, even patient inputs. In our system, different doctors—Doctor-1, Doctor-2, Hospital-1 with many doctors can store medical transaction records in the same system. Each doctor or hospital does not need to have separate EHR system to store medical transactions. Doctor1 in California running his own clinic and Hospital1 in New York would access the same m-ERP system.

2. The m-ERP system referred to in claim 1 can be used by different testing agencies like pathology, x-ray, sonogram to store their test results, digital photos too. That way seemingly disconnected medical service providers like Doctor1 in California and Lab1 in Florida would store medical records in the same centralized m-ERP system.

3. Centralization of medical records in one m-ERP system as referred to in claim 1 opens up unlimited possibilities of sharing them. A medical record created by Doctor-1 can be accessed by Doctor-2 without transferring the data in between systems or taking printouts and hard copies. The method of this sharing is called Authorization. This is our claim #3. By the process of Authorization Patient-1 allows Doctor-2 to review the diagnosis done by Doctor-1.

4. Each patient in the m-ERP system as claimed in 1 would have the option to nominate another person to make decisions on his or her behalf in case of incapacity. Nominee can take quick decisions like authorizing medical record access to new doctor or other end-of-life care decisions.

5. The method of segregated data storage in m-ERP system as claimed in 1 whereby enterprise records pertinent to the individual enterprise i.e. Clinic, Hospital, Lab are stored locally and medical transactions are centralized across enterprises.

6. The concept of data security in m-ERP system of claim 1 whereby different participants cannot access each other's records without valid authorization from respective patients or nominees. Example to clarify—Patient-1 is consulting two different doctors, Doctor-1 an orthopedic and Doctor-2 a gynecologist. Both doctors are storing their data in m-ERP. Still Doctor-2 does not have access to the diagnosis done by Doctor-1 unless she feels that she needs to know what medication has been prescribed by Doctor-1 before she prescribes some medication. This Data Security for different participants in the m-ERP system is our claim number 6.

7. The functional integration between different functional modules like Appointments, Medical Transactions, Insurance, Accounts Receivable, General Ledger, Accounts Payable in the m-ERP system of claim 1 is our claim #7. The same system can be used by a Hospital to manage their Appointments, account for their financial transactions, electronically store their medical records, bill insurance companies and patients, manage payroll and manage assets. It is a one-stop shop for the medical service providers.

8. The method of allowing patients to download their medical history from m-ERP system as discussed in claim 1, in Comma Delimited format—CSV format OR XML format. This report would be compatible to national standards to facilitate transfer of records between EHR systems.

9. The method of allowing patients to upload medical history to m-ERP system as discussed in claim 1 in CSV format OR in XML format in nationally accepted standard.

10. The method of assigning unique identifying membership number in the m-ERP system of claim 1. This ability to identify each member with unique membership number is one of the benefits of centralized data storage as proposed in m-ERP.

11. The unique numbering of medical transactions in m-ERP system in our claim #1. The medical transactions will be uniquely identified by a combination of the following elements—The Patient number+The Doctor number+The calendar year+the transaction number. The Transaction number would be a serial number unique to each calendar year. For example—
Patient number=12345678
Doctor number=1234
Year=2011
Transaction serial number in 2011=3456678
That makes the medical transaction number for the next transaction between Patient-12345678 and Doctor-1234 in 2011 as—12345678-1234-2011-3456679
That way each medical transaction in m-ERP can be uniquely identified from each other.

12. Presentation of data from the centrally stored medical records system, the m-ERP as in claim 1 would be available to members in HTML format. From the main HTML page, users would be able to drilldown to individual details that they wish.

| | | Identification all |
|---|---|---|
| Claim Nos. | Claim Dependency | claims |
| 1 | Independent | |
| 2 | Depends from 1 | 2/1 |
| 3 | Depends from 1 | 3/1 |
| 4 | Depends from 1 | 4/1 |
| 5 | Depends from 1 | 5/1 |
| 6 | Depends from 1 | 6/1 |
| 7 | Depends from 1 | 7/1 |
| 8 | Depends from 1 | 8/1 |
| 9 | Depends from 1 | 9/1 |
| 10 | Depends from 1 | 10/1 |
| 11 | Depends from 1 | 11/1 |
| 12 | Depends from 1 | 12/1 |
